(19) United States
(12) Patent Application Publication
(10) Pub. No.: US 2014/0254879 A1
(43) Pub. Date: Sep. 11, 2014

(54) Location Classification Based on License Plate Recognition Information

(71) Applicant: Shawn B. Smith, Portola Valley, CA (US)

(72) Inventor: Shawn B. Smith, Portola Valley, CA (US)

(21) Appl. No.: 14/201,830

(22) Filed: Mar. 8, 2014

Related U.S. Application Data
(60) Provisional application No. 61/774,782, filed on Mar. 8, 2013.

(51) Int. Cl. G06K 9/32

(52) U.S. Cl. CPC G06K 9/325
USPC 382/105

(57) ABSTRACT

Methods and systems for Methods and systems for classifying the locations of a vehicle of interest based on License Plate Recognition (LPR) instances are described herein. Locations associated with LPR instances matching a particular license plate number are classified based on LPR information gathered within search zones around each location. Clusters of one or more LPR instances associated with a target license plate number are identified. A search zone is defined around a cluster of one or more LPR instances associated with a target license plate number. LPR instances associated with other license plate numbers within the search zone are received from an LPR server, and a location associated with the search zone is classified based on LPR information gathered within the search zone. In some examples, the location classification is based on LPR activity matching a target license plate number, general LPR activity within the search zone, or both.

### CROSS REFERENCE TO RELATED APPLICATION

The present application for patent claims priority under 35 U.S.C. §119 from U.S. provisional patent application Ser. No. 61/774,782, entitled “Location Classification Based on License Plate Recognition Information,” filed Mar. 8, 2013, the subject matter of which is incorporated herein by reference.

### TECHNICAL FIELD

The described embodiments relate to License Plate Recognition (LPR) systems and tools for analysis of LPR information.

### BACKGROUND INFORMATION

License Plate Recognition (LPR) systems are typically employed to scan and log license plate information associated with vehicles parked in publically accessible areas. A typical LPR unit performs image analysis on captured images to identify the license plate number associated with each image. A typical LPR unit generates a record for each license plate number captured. The record may include any of an optical character recognition (OCR) interpretation of the captured license plate image (e.g., output in text string object format), images of the license plate number, a perspective image of the vehicle associated with the license plate number, the date and time of image capture, and the location of the LPR unit at the time of image capture. By continuing to operate each LPR unit for prolonged periods of time over a large area, the amount of aggregated LPR information grows. In addition, by combining the information generated by many LPR units, an LPR system may develop a large record of LPR information.

A large record of LPR information is useable for a variety of purposes. In one example, the location of a stolen vehicle may be identified based on a database of LPR information by searching the database for instances that match the license plate number of the stolen vehicle. Based on the time and location information that matches this license plate number, law enforcement officials may be able to locate the vehicle without costly investigation.

However, current methods of prioritizing resources aimed at locating vehicles often fail to adequately predict where a particular vehicle may be located at a particular time. Consequently, investigative efforts are often misallocated resulting in inefficiency. Thus, improvements are desired to assist in the prioritization of investigative work associated with locating vehicles of interest based on LPR information.

### SUMMARY

Methods and systems for classifying the locations of a vehicle of interest based on License Plate Recognition (LPR) instances are described herein. In one aspect, locations associated with LPR instances matching a particular license plate number are classified based on LPR information gathered within search zones around each address location.

In some embodiments, LPR instances associated with one or more target license plate numbers are received from an LPR server. Clusters of one or more LPR instances associated with a target license plate number are identified. In one example, a cluster is identified as a number of LPR instances associated with the same address and the target license plate number. In another example, a cluster is identified as a number of LPR instances associated with a target license plate number having a spatial density greater than a predetermined value within a population area of LPR instances.

In a further embodiment, a search zone is defined around a cluster of one or more LPR instances associated with a target license plate number. In some examples, the search zone is the population area associated with each cluster. In some other examples, the search zone is a predetermined shape (e.g., circle, ellipse, polygon, etc.) centered on a centroid of a spatial distribution of the cluster of LPR instances. In some other examples, the shape is a fixed size, or is scaled based on the population area. In some other examples, the cluster of one or more LPR instances associated with a target license plate number is overlayed on a map and the determination of the search zone is determined based in part on one or more features of the map.

In a further embodiment, LPR instances associated with other license plate numbers within the search zone are received from the LPR server, and a location associated with the search zone is classified based on LPR information gathered within the search zone.

In some examples, a plurality of LPR metrics are determined based on the plurality of LPR instances. Some LPR metrics are useful to determine how much is known about a target license plate number at a location associated with the search zone based on the received LPR information. In one example, the date a target license plate number was first captured at the location and the date a target license plate number was last captured at the location may be used to determine a time window when the target license plate number was associated with the location. In another example, the total number of times the target license plate number was captured at the location, the number of times the target license plate number was captured at the location during the daytime, and the number of times the target license plate number was captured at the location during the nighttime may be used to determine whether there is a strong association between the target license plate and the location, and whether the association is stronger during the daytime or nighttime.

Some other LPR metrics are useful to determine how much is known about the location associated with the search zone based on the received LPR information. For example, the total number of LPR site visits to the location, the number of LPR site visits during the daytime, and the number of LPR site visits during the nighttime are LPR metrics that indicate whether a particular location is well characterized by LPR information. In another example, the total number of LPR scans at a location associated with the search zone, the number of LPR scans at the location during the daytime, and the number of LPR scans at the location during the nighttime are LPR metrics that indicate whether a particular location is well characterized by LPR information. In yet another example, the total number of LPR scans at the location during a time window around a time the target license plate number was scanned at the location, the number of LPR scans at the location during the time window around the time the target license plate number was scanned at the location during the daytime, and the number of LPR scans at the location during the time window around the time the target license plate number was scanned at the location during the nighttime are LPR metrics that indicate whether a particular location is well characterized by LPR information during the relevant time period.

In another example, the average spatial density of vehicles scanned at the location during daytime LPR visits and the average spatial density of vehicles scanned at the location during nighttime LPR visits are LPR metrics that indicate a relative activity level at a particular location.

In another example, the number of unique license plate numbers scanned at the location over a time period and the number of unique license plate numbers that have been repeatedly scanned at the location over a time period are LPR metrics indicative of the diversity of visitors to a particular location and whether the same vehicles repeatedly return to the same location.

A location within a search zone is classified based at least in part on one or more LPR metrics derived from LPR information gathered within the search zone. Exemplary classifications include, residential location, workplace location, retail location, public location, etc. In one example, a location is classified based on a ratio of LPR instances captured during daytime and LPR instances captured during nighttime. For example, a location may be classified as residential based on a large ratio of nighttime LPR instances relative to daytime LPR instances. In another example, a location may be classified as a workplace based on a large ratio of daytime LPR instances relative to nighttime LPR instances and a large percentage of license plate numbers scanned at least three times at the location. In yet another example, a location may be classified as a workplace based on a large ratio of daytime LPR instances relative to nighttime LPR instances and a large percentage of license plate numbers scanned at least two times at the location.

The foregoing is a summary and thus contains, by necessity, simplifications, generalizations, and omissions of detail; consequently, those skilled in the art will appreciate that the summary is illustrative only and is not limiting in any way. Other aspects, inventive features, and advantages of the devices and/or processes described herein will become apparent in the non-limiting detailed description set forth herein.

### BRIEF DESCRIPTION OF THE DRAWINGS

FIG. 1 is a simplified diagram illustrative of a License Plate Recognition (LPR) system 100.

FIG. 2 is a simplified diagram illustrative of a plurality of LPR instances 141.

FIG. 3 is a simplified diagram illustrative of the plurality of LPR instances of FIG. 2 annotated with address information.

FIG. 4 is a simplified diagram illustrative of a Location Classification tool 105 operable in accordance with the methods described herein.

FIG. 5 is a flowchart illustrative of a method 200 of classifying a location based on LPR information gathered within a search zone around the location.

FIG. 6 is a simplified diagram illustrative of a number of LPR instances plotted over an area 146.

FIG. 7 is a simplified diagram illustrative of a location classification engine 500 configured to implement Location Classification functionality as described herein.

### DETAILED DESCRIPTION

Reference will now be made in detail to background examples and some embodiments of the invention, examples of which are illustrated in the accompanying drawings.

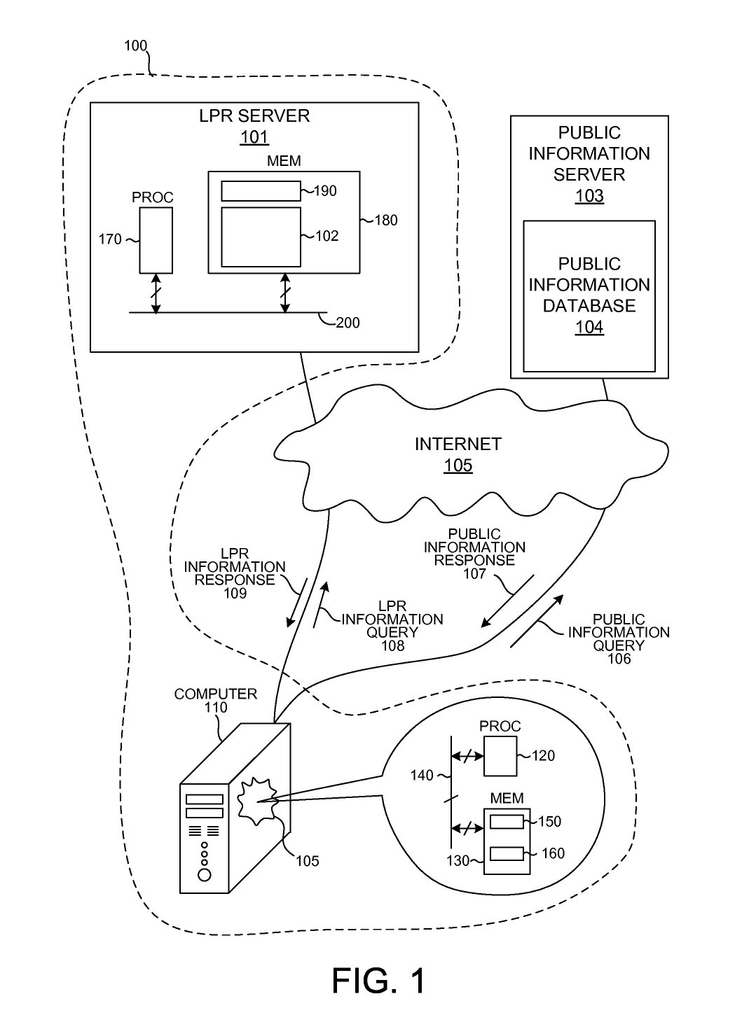

FIG. 1 is a diagram illustrative of a License Plate Recognition (LPR) system 100 that includes an LPR server 101 that stores a database 102 of LPR instances and a general purpose computer 110 operable to implement tools useful to classify the locations of a vehicle of interest based on License Plate Recognition (LPR) instances.

LPR server 101 includes a processor 170 and an amount of memory 180. Processor 170 and memory 180 may communicate over bus 200. Memory 180 includes an amount of memory 190 that stores a database program executable by processor 170. Exemplary, commercially available database programs include Oracle®, Microsoft SQL Server®, IBM DB2®, etc. Memory 180 also includes an amount of memory that stores an LPR database 102 of LPR instances searchable by the database program executed by processor 170. Computer 110 includes a processor 120 and a memory 130. Processor 120 and memory 130 may communicate over bus 140. Memory 130 includes an amount of memory 150 that stores a number of LPR instances. Memory 130 also includes an amount of memory 160 that stores program code that, when executed by processor 120, causes processor 120 to implement Location Classification (LC) functionality by operation of LC tool 105.

LPR system 100 may include a camera module (not shown) that captures an image of each license plate. In some embodiments, the camera module is attached to a vehicle, or may be a handheld device operated by a person operating a vehicle. The vehicle roves through publically accessible areas capturing license plate images. LPR system 100 may also include a location module (not shown) that determines the physical location and time of each image capture. For example, the LPR system may include a global positioning system (GPS) module that determines the physical location and time of each image capture. In some other embodiments, the camera module is located in a fixed position with a view of passing vehicles (e.g., along a roadside, mounted to a traffic signal, etc.). As vehicles travel by the fixed position, the camera module captures an image of each license plate. In these embodiments, a GPS module may not be employed because the fixed position is known a priori.

LPR system 100 may perform image analysis on each collected image to identify the license plate number associated with each image. Finally, LPR system 100 stores a record of each license plate number identified, and the time and location associated with each image capture as an LPR instance in LPR database 102 stored on LPR server 101.

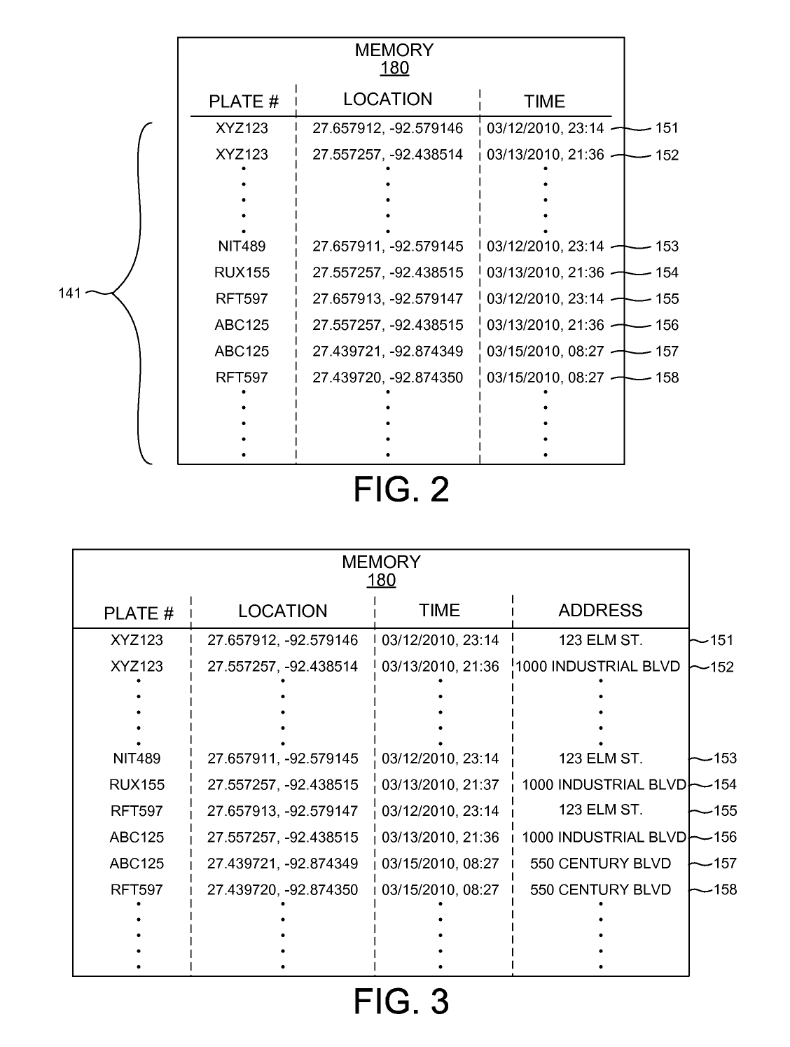

FIG. 2 is illustrative of a plurality of LPR instances 141 stored in memory 180. An LPR instance includes an indication of the particular vehicle license plate number recognized by an LPR system 100 at a particular location and time. In the example illustrated in FIG. 2, LPR instances 151-158 each record an indication of the recognized vehicle license plate number, an indication of the location where the date was recognized, and an indication of the time that the plate was recognized. In other examples, additional information may be stored with any LPR instance. For example, an index identifier may be associated with each LPR instance. The index identifier may be useful to facilitate sorting and organizing the plurality of LPR instances. In another example, an amount of image data indicating a visual image of the vehicle that includes the vehicle license plate may be associated with each LPR instance. This may be useful to allow a human to visually confirm the license plate number recognized by the LPR system. In another example, an identifier of the address at the location of the LPR instance may be appended to an LPR instance. For example, as illustrated in FIG. 3, the address may be annotated for each LPR instance.

As illustrated in FIG. 3, LPR instance 151 indicates that a license plate number “XYZ123” was recognized by LPR system 100 at the location given by GPS coordinates “27.657912, −92.79146” at 11:14 pm on Mar. 12, 2010. LPR instance 152 indicates that the same license plate number was recognized by LPR system 100 at a different location and time. LPR instance 153 indicates that a license plate number “NIT489” was recognized by LPR system 100 at approximately the same location as LPR instance 151 at approximately the same time. LPR instance 154 indicates that a license plate number “RUX155” was recognized by LPR system 100 at approximately the same location as LPR instance 152 at approximately the same time.

In the embodiment depicted in FIG. 1, computer 110 is communicatively linked to LPR server 101 via the Internet 105. However, computer 110 may be communicatively linked to LPR server 101 by any communication link known to those skilled in the art. For example, computer 110 may be communicatively linked to LPR server 101 over a local area network (LAN) or over a wireless network. Similarly, computer 110 may also be communicatively linked to a public information server 103 via the Internet 105. A public information server 103 stores a database 104 of publically available information. As used herein, publically available information includes both information that is only available to parties with a permissible purpose (e.g., law enforcement, etc.) and information that is available without restrictions on purpose of use. Examples of publically available information include vehicle registrations, information from private investigative reports, and information from public investigative reports (e.g., law enforcement profiles). Other sources of information may be contemplated (e.g., property records, birth records, death records, marriage records, etc.). By way of example, a database 104 of property records may be stored on a server 103 administered by a government entity (e.g., Alameda County, California, USA). Other databases 104 of publically available information may be stored on servers 103 administered by private organizations (e.g., LexisNexis®, accessible at www.lexisnexis.com, TLO®, accessible at www.tlo.com, etc.). Some public information servers 103 are accessible to the public without a fee; others require payment of a fee to become accessible.

LPR database 102 is searchable based on the indication of a license plate number communicated by LPR information query 108. In some embodiments, LPR database 102 is indexed for efficient search by tools available with commercially available database software packages (e.g., Oracle®, Microsoft SQL Server®, IBM DB2®, etc.). In this manner, LPR database 102 is configured to be efficiently searched by the desired license plate numbers and search zones communicated by LPR information query 108. LPR information query 108 may be any format known to those skilled in the art (e.g., HTML script, PERL script, XML script, etc.).

In response to receiving LPR information query 108, LPR server 101 communicates LPR information response 109 to computer 110. In one example, LPR information response 109 includes the list of LPR instances 141 depicted in FIG. 2. LPR information response 109 may include the search results in any format known to those skilled in the art (e.g., HTML, XML, ASCII, etc.).

Computer 110 executing LC tool 105 is configured to receive one or more LPR information responses 109 and store the information in memory 150. This information is accessible by LC tool 105 for further analysis. In one example, LC tool 105 parses the received information and generates a Microsoft Excel® spreadsheet that presents the received information in an organized manner (e.g., tables with headings, plots, charts, etc.). In one example, LC tool 105 includes Microsoft Excel® scripts that perform additional analysis and present results to a user in accordance with the methods described herein.

In one aspect, locations associated with LPR instances matching a particular license plate number are classified based on LPR information gathered within search zones around each address location. The following illustrations and corresponding explanations are provided by way of example as many other exemplary operational scenarios may be contemplated.

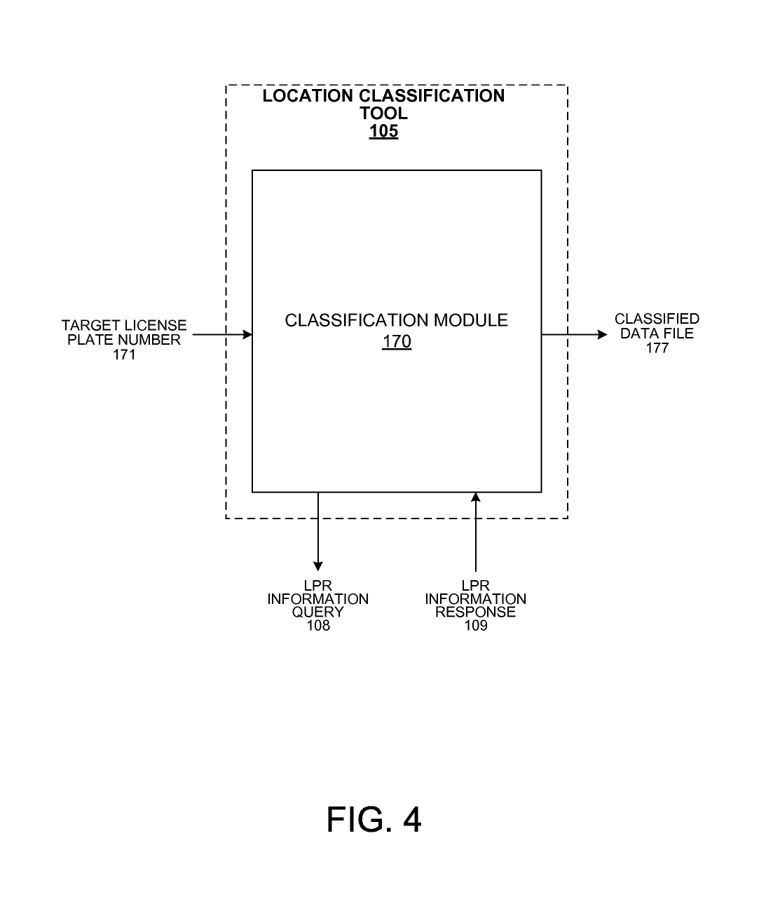

FIG. 4 is illustrative of a LC tool 105 operable in accordance with the methods described herein. In the embodiment depicted in FIG. 4, LC tool 105 includes a classification module 170. Classification module 170 receives at least one license plate number 171, and in response, generates a classified data file 177 that communicates a classification of at least one location associated with an LPR instance of license plate number 171. The classification is determined in accordance with any of the non-limiting, exemplary methods described herein.

In some embodiments, LPR instances associated with one or more target license plate numbers 171 are solicited by LC tool 105. For example, LC tool 105 transmits a LPR information query 108 to LPR server 101 requesting LPR server 101 to return LPR instances associated with one or more target license plate numbers 171. In response, LPR server 101 transmits a LPR information response 109 including the requested LPR instances.

In some examples, LC tool 105 receives the LPR instances associated with a target license plate number 171 and determines a cluster of one or more LPR instances associated with (e.g., matching) the target license plate number.

In one example, LC tool 105 determines a cluster as a number of LPR instances associated with the same address and the target license plate number. For example, if the number of LPR instances associated with the same address and target license plate number exceeds a predetermined threshold value (e.g., two or more, three or more, etc.), the LPR instances are identified as a cluster.

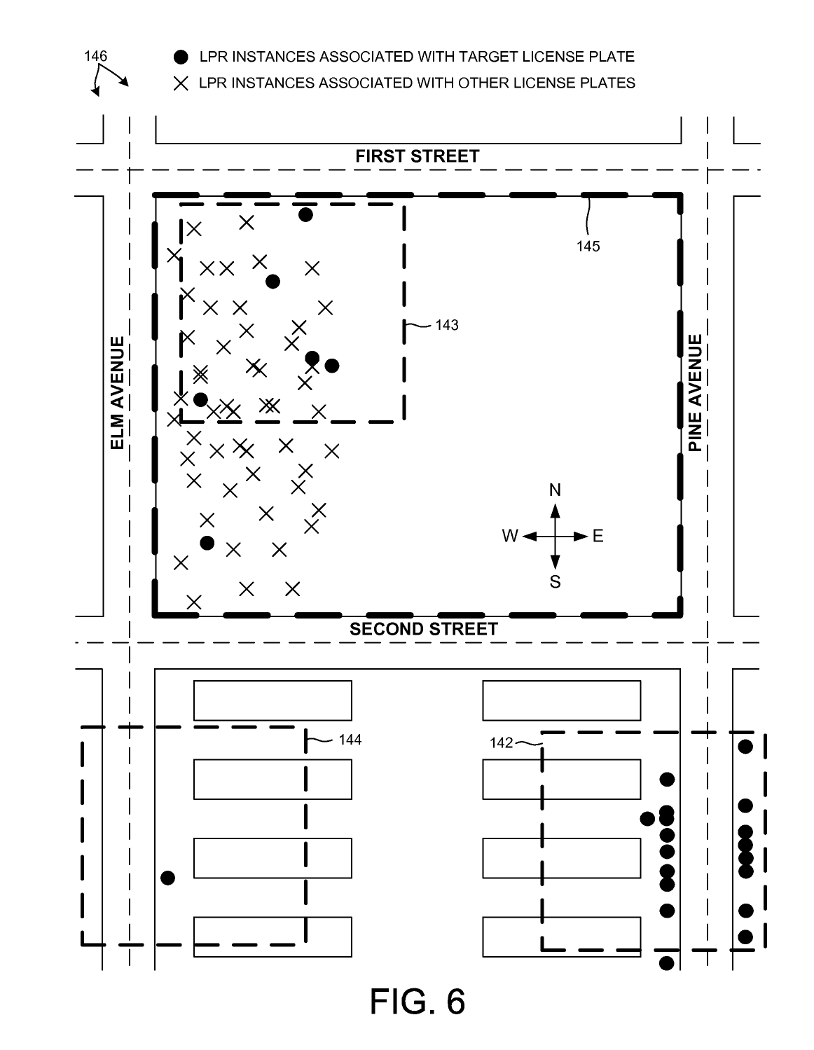

In another example, LC tool 105 determines a cluster as a number of LPR instances associated with a target license plate number having a spatial density greater than a predetermined value within a population area of LPR instances. As illustrated in FIG. 6, a number of LPR instances associated with a target license plate number received by LC tool 105 are plotted as dots over an area 146. As illustrated, a high density population of LPR instances associated with the target license plate number exists on Pine Avenue, south of Second Street, within population area 142, a medium density population of LPR instances associated with the target license plate number exists near the southeast corner of Elm Avenue and First Street, within population area 143, and a low density population of LPR instances associated with the target license plate number exists on Elm Avenue, south of Second Street, within population area 144. In the illustrated example, each of population areas 142, 143, and 144 are a fixed size, however, in other examples, the size of a particular population area may be changed to accommodate different sized populations.

In one example, LC tool 105 determines whether an LPR instance should be treated as part of a cluster based on whether the spatial density of LPR instances within a population area exceeds a predetermined threshold value. Similarly, in another example, LC tool 105 determines a cluster when the number of LPR instances associated with a target license plate number within a population area of LPR instances exceeds a predetermined threshold value.

In a further embodiment, LC tool 105 determines a search zone around a cluster of one or more LPR instances associated with a target license plate number. In one example, the search zone is the population area associated with each cluster. In another example, the search zone is a predetermined shape (e.g., circle, ellipse, polygon, etc.) centered on a centroid of a spatial distribution of the cluster of LPR instances. In some examples, the shape is a fixed size. In some other examples, the shape size is scaled based on the population area. In some other examples, the cluster of one or more LPR instances associated with a target license plate number is overlayed on a map and the determination of the search zone is based at least in part on one or more features of the map. For example, LPR instances are plotted over an area 146 illustrated in FIG. 6. In addition, a street map of the same area is also illustrated. In this manner, the locations of each LPR instance may be referenced to a street map that includes specific streets, address locations, lot locations, etc. In one example, LC tool 105 may determine a search zone 145 that includes the entire block bounded by Elm Avenue, Pine Avenue, First Street, and Second Street. In this example, the street locations of the map are used to determine the search zone. In another example, LC tool 105 may determine a search zone (not shown) that includes a parking lot within the block bounded by Elm Avenue, Pine Avenue, First Street, and Second Street. In this example, lot line indicators of the map are used to determine the search zone. Search zones may be determined based on many other features of a map or map images (e.g., satellite images, etc.).

In a further embodiment, LC tool 105 solicits additional LPR instances associated with other license plate numbers within the search zone. For example, LC tool 105 transmits a LPR information query 108 to LPR server 101 requesting LPR server 101 to return LPR instances associated all license plate numbers captured within the search zone. In response, LPR server 101 transmits a LPR information response 109 including the requested LPR instances. As illustrated in FIG. 6, LPR instances associated any license plate numbers captured within the search zone 145 associated with a target license plate number are plotted as crosses within search zone 145.

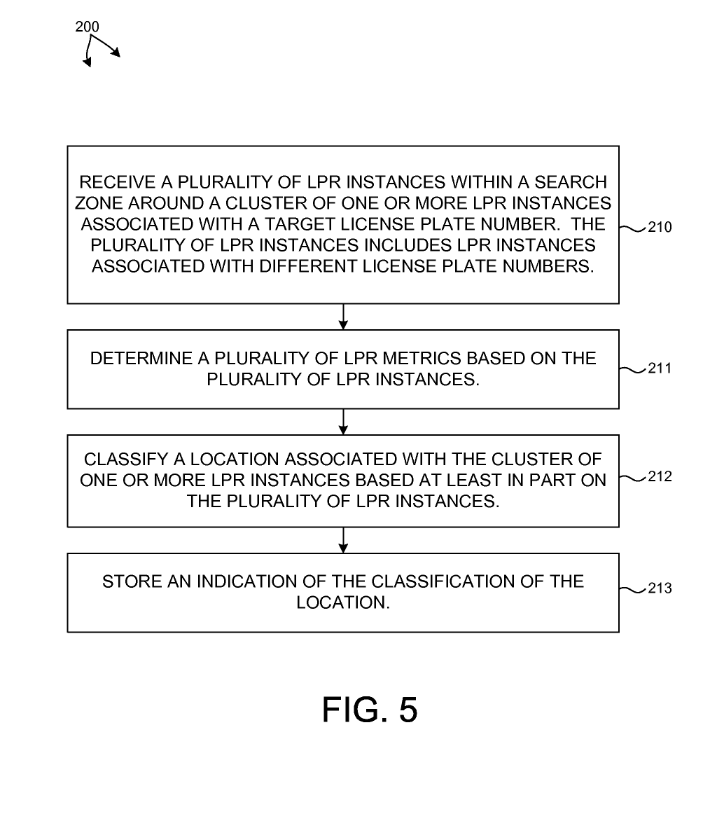

FIG. 5 illustrates a method 200 of classifying a location associated with a search zone based on LPR information gathered within the search zone. In one, non-limiting embodiment, classification module 170 executes LC functionality in accordance with method 200.

In block 210, classification module 170 receives a plurality of LPR instances within a search zone around a cluster of one or more LPR instances associated with a target license plate number. The plurality of LPR instances includes LPR instances associated with different license plate numbers.

In block 211, classification module 170 determines a plurality of LPR metrics based on the plurality of LPR instances. A wide variety of LPR metrics useful for classification of a location associated with a search zone may be derived from the received LPR instances. The following are mentioned by way of non-limiting example.

Some LPR metrics are useful to determine how much is known about a target license plate number at a location associated with a search zone based on the received LPR information. In one example, the date a target license plate number was first captured at the location and the date a target license plate number was last captured at the location may be used to determine a time window when target license plate number was associated with the location based on LPR information. In another example, the total number of times the target license plate number was captured at the location, the number of times the target license plate number was captured at the location during the daytime, and the number of times the target license plate number was captured at the location during the nighttime may be used to determine whether there is a strong association between the target license plate and the location, and whether the association is stronger during the daytime or nighttime. In yet another example, the number of times the target license plate number was captured at the location as a percentage of the total number of LPR scans at the location may be used to determine whether there is a strong association between the target license plate and the location.

Some LPR metrics are useful to determine how much is known about the location associated with the search zone based on the received LPR information.

For example, the total number of LPR site visits to the location, the number of LPR site visits during the daytime, and the number of LPR site visits during the nighttime are LPR metrics that indicate whether a particular location is well characterized by LPR information. An LPR site visit is a period of time where an LPR unit approached a particular location, collected LPR information, and subsequently left the area. For example, an LPR unit may first visit an apartment complex between 4:30 pm and 4:45 am on Jan. 10, 2009. During this visiting time period, the LPR unit scans the license plates of many vehicles parked in and around the apartment complex. The LPR instances generated during this visiting time period may be identified as a LPR site visit because all of these LPR instances were gathered over a relatively short period of time. A few weeks later, the LPR unit may revisit the apartment complex between 2:30 pm and 3:00 pm on Mar. 4, 2009. Again, during this period of time, the LPR unit scans the license plates of many vehicles parked in and around the apartment complex. The LPR instances generated during this period of time are grouped into another LPR site visit. In some examples, LC tool 105 distinguishes LPR site visits by analyzing the time stamps of each LPR instance of the received LPR instances. In one example, LC tool 105 arranges the LPR instances in chronological order and steps through the chronologically ordered list. LC tool 105 determines the time difference between successive LPR instances based on their respective time stamps. If the time difference between successive LIP instances is less than a predetermined threshold, then the two LPR instances are identified with the same LPR site visit. If the time difference between successive LIP instances is greater than a predetermined threshold, the successive LPR instances are identified with different LPR site visits. The predetermined threshold value may be assigned automatically or received from a user. In one example, the predetermined threshold value is five minutes; however, other values may be contemplated.

In another example, the total number of LPR scans at a location associated with the search zone, the number of LPR scans at the location during the daytime, and the number of LPR scans at the location during the nighttime are LPR metrics that indicate whether a particular location is well characterized by LPR information.

In another example, the total number of LPR scans at the location during a time window around a time the target license plate number was scanned at the location, the number of LPR scans at the location during the time window around the time the target license plate number was scanned at the location during the daytime, and the number of LPR scans at the location during the time window around the time the target license plate number was scanned at the location during the nighttime are LPR metrics that indicate whether a particular location is well characterized by LPR information during the relevant time period.

In another example, the average spatial density of vehicles scanned at the location during daytime LPR visits and the average spatial density of vehicles scanned at the location during nighttime LPR visits are LPR metrics that indicate a relative activity level at a particular location.

In another example, the number of unique license plate numbers scanned at the location over a time period and the number of unique license plate numbers that have been repeatedly scanned at the location over a time period are LPR metrics indicative of the diversity of visitors to a particular location and whether the same vehicles repeatedly return to the same location. In some examples, the number of unique license plate numbers that have been scanned once, twice, three times, four times, etc., may be separately determined. In addition, the number of unique license plate numbers that have been scanned once, twice, three times, four times, etc., as a percentage of the total number of unique license plate numbers may be separately determined.

In block 212, classification module 170 classifies a location within a search zone associated with the cluster of one or more LPR instances based at least in part on one or more LPR metrics derived from LPR information gathered within the search zone. Exemplary classifications include, residential location, workplace location, retail location, public location, etc. These classifications are provided by way of non-limiting example. Other classifications may be contemplated and different levels of classification may also be contemplated. For example, a residential location may be further categorized, by way of example, into “single family residence,” “duplex”, “multi-family residence,” etc.

In one example, the location is classified based on a ratio of LPR instances captured during daytime and LPR instances captured during nighttime within a search zone associated with the location. For example, classification module 170 may classify a location as residential based on a large ratio of nighttime LPR instances relative to daytime LPR instances within the search zone. In another example, classification module 170 may classify a location as a workplace based on a large ratio of daytime LPR instances relative to nighttime LPR instances and a large percentage of license plate numbers scanned multiple times (e.g., at least two times, at least three times, etc.) at the location. For example, if more than 50% of the license plates scanned at the location have been scanned at that location multiple times during the daytime, this indicates that the location is likely a workplace. In yet another example, classification module 170 may classify a location as a retail/public location (e.g., shopping mall, stadium, etc.) based on a small percentage of license plate numbers scanned multiple times (e.g., at least two times, at least three times, etc.) at the location. For example, if less than 20% of the license plates scanned at the location have been scanned at that location multiple times, this indicates that the location is likely the site of a retail/public establishment.

In block 213, classification module 170 stores an indication of the classification of the location in a memory (e.g., memory 150). In some examples, LC tool 105 communicates the classifications to the user, for example, by generating a report (e.g., text file). A classified data file 177 includes the classification associated with each cluster of LPR instances associated with each target license plate number. In some examples LC tool 105 communicates the classifications to a large intelligence database that may be subjected to data mining by an advance application. For example, commercially available data mining software tools (e.g., data mining tools available from Oracle or IBM) or customized data mining software may operate on the large database to prioritize investigative efforts based at least in part on the classifications. In these embodiments LC tool 105 generates an electronic data file including, for example, the classifications associated with each location. This file may be appended to the large database subject to additional data mining steps.

As discussed above, any of the methods described herein may be executed by LC tool 105 running within computer 110. An operator may interact with LC tool 105 via a locally delivered user interface (e.g., GUI displayed by terminal equipment directly connected to computer 110). In other embodiments, an operator may interact with LC tool 105 via a web interface communicated over the internet.

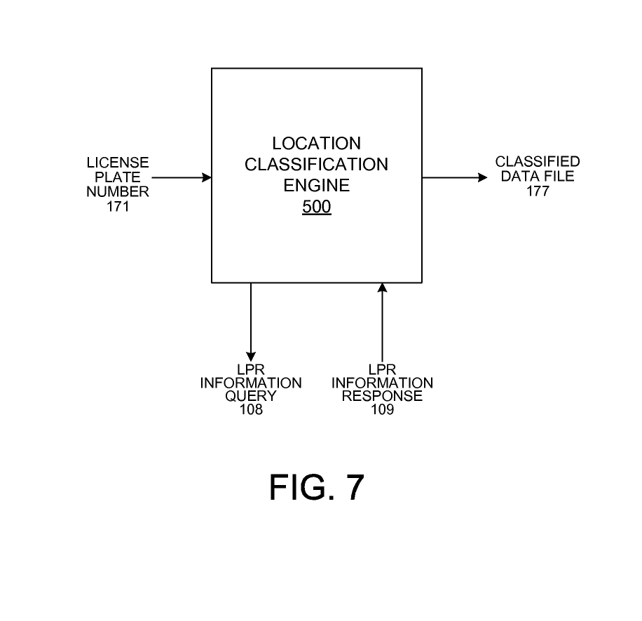

Although, the methods described herein may be executed by LC tool 105 running within computer 110, it may also be executed by dedicated hardware. FIG. 7 illustrates a location classification engine 500 configured to implement LC functionality as discussed herein. In one example, location classification engine 500 receives one or more license plate numbers 171 as input. Location classification engine 500 implements LC functionality as discussed herein and generates a classified data file 177 based on the classifications associated with each location.

Although, aspects of the methods described herein are discussed with reference to determining LPR instances within search zones, in general, the same aspects may also involve determining LPR instances within any number of time windows.

Although, the methods described herein are introduced separately, any of these methods may be combined with any of the other methods to comprise LC functionality.

Any of the methods described herein may involve communicating LPR information and location classification information to an entity via classified data file 177. Classified data file 177 may be in electronic form (e.g., spreadsheet file, text file, graphics file, etc.) that indicates the location classification to a user viewing the file. In addition, any of the methods described herein may each involve receiving instructions from an entity. The instructions may be in electronic form (e.g., batch file, response to query, command input, etc.).

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Although certain specific embodiments are described above for instructional purposes, the teachings of this patent document have general applicability and are not limited to the specific embodiments described above. Accordingly, various modifications, adaptations, and combinations of various features of the described embodiments can be practiced without departing from the scope of the invention as set forth in the claims.

What is claimed is:

1. A method comprising:
receiving a plurality of LPR instances within a search zone around a cluster of one or more LPR instances associated with a target license plate number, wherein the plurality of LPR instances includes LPR instances associated with a plurality of different license plate numbers;
determining one or more LPR metrics based on the plurality of LPR instances;
classifying a location associated with the cluster of one or more LPR instances based at least in part on the one or more LPR metrics; and
storing an indication of the classification of the location.

2. The method of claim 1, further comprising:
determining the cluster of one or more LPR instances associated with the target license plate number when a number of LPR instances associated with the target license plate number within a population area exceeds a predetermined threshold value.

3. The method of claim 1, further comprising:
determining the cluster of one or more LPR instances associated with the target license plate number as a population of LPR instances associated with the target license plate number having a spatial density greater than a predetermined value.

4. The method of claim 1, further comprising:
determining the search zone around the cluster of one or more LPR instances associated with a target license plate number.

5. The method of claim 4, wherein the search zone is a predetermined shape centered on a centroid of a spatial distribution of the cluster of LPR instances associated with the target license plate number.

6. The method of claim 4, wherein the determining the search zone comprises,
overlaying the cluster of one or more LPR instances associated with the target license plate number on a map, and
determining the search zone based at least in part on one or more features of the map.

7. The method of claim 1, wherein the classifying the location associated with the cluster of one or more LPR instances involves a ratio of LPR instances captured during daytime and LPR instances captured during nighttime within the search zone.

8. The method of claim 1, wherein the classifying the location associated with the cluster of one or more LPR instances involves a percentage of license plate numbers scanned at least two times within the search zone.

9. The method of claim 1, further comprising:
transmitting a first LPR information query to a LPR database, the LPR information query including an indication of a vehicle license plate number;
receiving an address associated with at least one License Plate Recognition (LPR) instance that matches the license plate number in response to the LPR information query, the at least one LPR instance having been previously identified by a LPR system; and
transmitting a second LPR information query to the LPR database, the LPR information query including the search zone around the cluster of one or more LPR instances associated with the target license plate number.

10. An apparatus comprising:
a processor; and
a memory storing an amount of program code that, when executed, causes the apparatus to
receive a plurality of LPR instances within a search zone around a cluster of one or more LPR instances associated with a target license plate number, wherein the plurality of LPR instances includes LPR instances associated with a plurality of different license plate numbers;
determine a plurality of LPR metrics based on the plurality of LPR instances;
classify a location associated with the cluster of one or more LPR instances based at least in part on the plurality of LPR instances; and
store an indication of the classification of the location.

11. The apparatus of claim 10, the memory also storing an amount of program code that, when executed, causes the apparatus to:
determine the cluster of one or more LPR instances associated with the target license plate number as a number of LPR instances associated with the same address, wherein the number exceeds a predetermined threshold value.

12. The apparatus of claim 10, the memory also storing an amount of program code that, when executed, causes the apparatus to:
determine the cluster of one or more LPR instances associated with the target license plate number as a population of LPR instances associated with the target license plate number having a spatial density greater than a predetermined value.

13. The apparatus of claim 10, the memory also storing an amount of program code that, when executed, causes the apparatus to:
determine the search zone around the cluster of one or more LPR instances associated with a target license plate number.

14. The apparatus of claim 13, wherein the search zone is a predetermined shape centered on a centroid of a spatial distribution of the cluster of LPR instances associated with the target license plate number.

15. The apparatus of claim 13, wherein the determining the search zone involves overlaying the cluster of one or more LPR instances associated with the target license plate number on a map, and determining the search zone based at least in part on one or more features of the map.

16. The apparatus of claim 10, wherein the classifying the location associated with the cluster of one or more LPR instances involves a ratio of LPR instances captured during daytime and LPR instances captured during nighttime within the search zone.

17. The apparatus of claim 10, wherein the classifying the location associated with the cluster of one or more LPR instances involves a percentage of license plate numbers scanned at least two times within the search zone.

18. The apparatus of claim 10, the memory also storing an amount of program code that, when executed, causes the apparatus to:
transmit a first LPR information query to a LPR database, the LPR information query including an indication of a vehicle license plate number;
receive an address associated with at least one License Plate Recognition (LPR) instance that matches the license plate number in response to the LPR information query, the at least one LPR instance having been previously identified by a LPR system; and
transmit a second LPR information query to the LPR database, the LPR information query including the search zone around the cluster of one or more LPR instances associated with the target license plate number.

19. A non-transitory, computer-readable medium, comprising:
code for causing a computer to receive a plurality of LPR instances within a search zone around a cluster of one or more LPR instances associated with a target license plate number, wherein the plurality of LPR instances includes LPR instances associated with a plurality of different license plate numbers;
code for causing the computer to determine one or more LPR metrics based on the plurality of LPR instances;
code for causing the computer to classify a location associated with the cluster of one or more LPR instances based at least in part on the one or more LPR metrics; and
code for causing the computer to store an indication of the classification of the location.

20. The non-transitory, computer-readable medium of claim 19, further comprising:
code for causing the computer to determine the cluster of one or more LPR instances associated with the target license plate number when a number of LPR instances associated with the target license plate number within a population area exceeds a predetermined threshold value.
